(19) United States
(12) Patent Application Publication
(10) Pub. No.: US 2004/0030608 A1
(43) Pub. Date: Feb. 12, 2004

(54) Communicating apparatus with scanning function

(76) Inventors: Say-Yee Wen, Taipei (TW); Shih-Li Wen, Taipei (TW); Hsiang-Min Liu, Taipei (TW); I-Ping Hu, Taipei (TW)

Correspondence Address: BIRCH STEWART KOLASCH & BIRCH, PO BOX 747, FALLS CHURCH, VA, 22040-0747, US

(21) Appl. No.: 10/386,493

(22) Filed: Mar. 13, 2003

(30) Foreign Application Priority Data
Jun. 10, 2002 (TW) 091112495

(51) Int. Cl. G06F 17/60

(52) U.S. Cl. 705/26

(57) ABSTRACT

A communicating apparatus with scanning function, the communicating apparatus comprising: a scanning module for scanning a bar code of a merchandise; a memory unit for saving the bar code of the merchandise; an encoding/decoding module for processing the bar code of the merchandise; a data transmitting interface for transmitting the bar code of the merchandise and its relevant data; a displaying module for browsing the bar code of the merchandise and the relevant data; and a central processing unit(CPU) for processing the memory, transmission, and communication of the bar code. As a result, user can scan the bar code of any merchandise to be purchased or inquired using the communication apparatus with scanning function, and then transmitting the data associated with the bar code as a radio wave to distant end process platform in-built with a database for all types of merchandise. Thus, the user can find out the merchandise corresponding to the bar code, so as to accomplish the purchase and inquiry of the desired merchandise from the user end.

### BACKGROUND OF THE INEVENTION

1. Field of Invention

The present invention generally relates to a communicating apparatus. More particularly, the present invention relates to a communicating apparatus with a scanning function and is applicable to an electronic shopping system, such that the communicating apparatus scans the bar code of a merchandise and transmits a message for the bar code to the process platform in-built with a merchandise database, where the message for the bar code is matched with the merchandise to complete the service in the electronic shopping system.

2. Description of Related Art

Typically, when consumers decide to purchase merchandise, most of them would prefer a traditional way of shopping in the stores. Although shopping in the stores provide a good interaction between the consumer and the merchandise supplier, it may cost the consumer a huge amount of time and effort in transportation and searching for the merchandise. Therefore, this way of shopping becomes an inconvenient choice for consumers who do not have a lot of spare time to do shopping, do not wish to spend time on transportation and searching merchandise, or wish to have a specific merchandise bought instantly.

Recently, Internet has been applicable in a wide diversity, allowing the consumers to shop on the Internet for a variety of products without leaving their places. Generally, in the online shopping method and system, the end user usually requires a terminal equipment, such as a personal computer (PC) to link to a shopping website through Internet. A wide variety of merchandises is then displayed by the shopping website, so that the end user can pick from the product list to make order for the merchandise. And when the end user has finished picking the merchandises to be purchased from the product list, the amount for each merchandise picked by the end user is added up by the shopping website. After the end user has confirmed to purchase, the online shopping is complete.

However, the conventional online shopping method has several drawbacks making this way of shopping inconvenient. For example, people do not usually carry computer with them to do online shopping, and not all locations are provided with Internet service. Also, when the end user only needs to purchase specific merchandise, he/she still has to search from the product list comprising many types of merchandise, causing a lot of time being wasted. In this case, the consumer is not provided with an instant, fast and convenient way of shopping.

### SUMMARY OF THE INVENTION

To improve the drawbacks associated with the shopping method described above, an objective the present invention is to provide a communicating apparatus with a scanning function applicable to the shopping system. By making all types of merchandise and their information into bar codes, the bar code of the merchandise is then scanned by the communicating apparatus with the scanning function, so the bar code message for the merchandise is transmitted by the communicating apparatus to the process platform at the distant end, so as to complete the purchase or search for the merchandise instantly, saving the consumer's time for shopping.

As embodied and broadly described herein, the shopping system that employs the communicating apparatus with the scanning function according to the present invention comprises: a communicating apparatus with a scanning function and a distant process platform. The communicating apparatus with scanning function serves to scan, record, and transmit the bar code related to the merchandise for the end user. The communicating apparatus comprises a scanning module for scanning the bar code of the merchandise; an access memory unit for temporarily saving the bar code; an encoding/decoding module for further processing the bar code message; a data transmission interface for transmitting the bar code and other related messages; a displaying module for displaying the bar code and information related to the merchandise; and a central processing unit (CPU0 for processing the memory, transmission, communication functions related to the bar code in the communicating apparatus. The process platform receives the bar code and other related operation message transmitted by the apparatus with the scanning function, so as to determine the user's identity and content of the desired merchandise. The information related to the merchandise is then transmitted to the end user to complete the purchase of the merchandise. The process platform comprises a user database for storing information of the registered member; an identification process module for determining if the end user has an authority to enter the shopping system according to content in the user database; a merchandise database for storing a plurality of merchandise information which includes at least the identity code corresponding to the merchandise; a merchandise searching process module for matching the bar code message transmitted by the end user with the merchandise content in the merchandise database; and a data transmission interface for transmitting the information related to the merchandise to the user end and the stores.

The shopping method that employs the communicating apparatus with the scanning function according to the present invention involves scanning the bar code of the merchandise to be purchased from the merchandise catalog by the communicating apparatus with the scanning function, followed by transmitting the bar code to a process platform at distant end. According to the merchandise database previously established in the process platform, the bar code is matched with its corresponding merchandise to located the merchandise desired by the end user, so as to complete the purchase of the merchandise by the end user. The method comprises at least the steps of: the end user scanning the bar code of the merchandise to be purchased using the communicating apparatus with the scanning function; transmitting the bar code together with the communication identity code to the distant process platform; the distant process platform determining the identity of the end user and the merchandise to be purchased according to the communication identity code and the merchandise database previously established; and the process platform transmitting the trade information related to the merchandise to the end user and to the store that provides the merchandise in order to complete the purchase of the merchandise. Alternatively, the end user can scan the bar code of the merchandise using the communicating apparatus with the scanning function and transmit the bar code to the distant process platform, so as to search the information, such as specs, feature, cost, and after sale service of the merchandise. The method comprises the steps of: the end user scanning the bar code of the merchandise to be searched using the communicating apparatus with the scanning function; transmitting the bar code together with the communication identity code to the distant process platform; the process platform searching information of the merchandise according to the communication identify code and the merchandise database previously established; the process platform transmitting the information of the merchandise to the communicating apparatus, where the end user can browse the information, so as to complete the search for the information of the merchandise.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a block diagram illustrating the system for shopping by a communicating apparatus with a scanning function according to the present invention;

FIG. 2 is a flow chart illustrating the system for shopping by the communicating apparatus with a scanning function according to the present invention; and

FIG. 3 is a flow chart illustrating the method of searching information related to the merchandise by the communicating apparatus with a scanning function according to the present invention.

### DESCRIPTION OF THE PREFERRED EMBODIMENTS

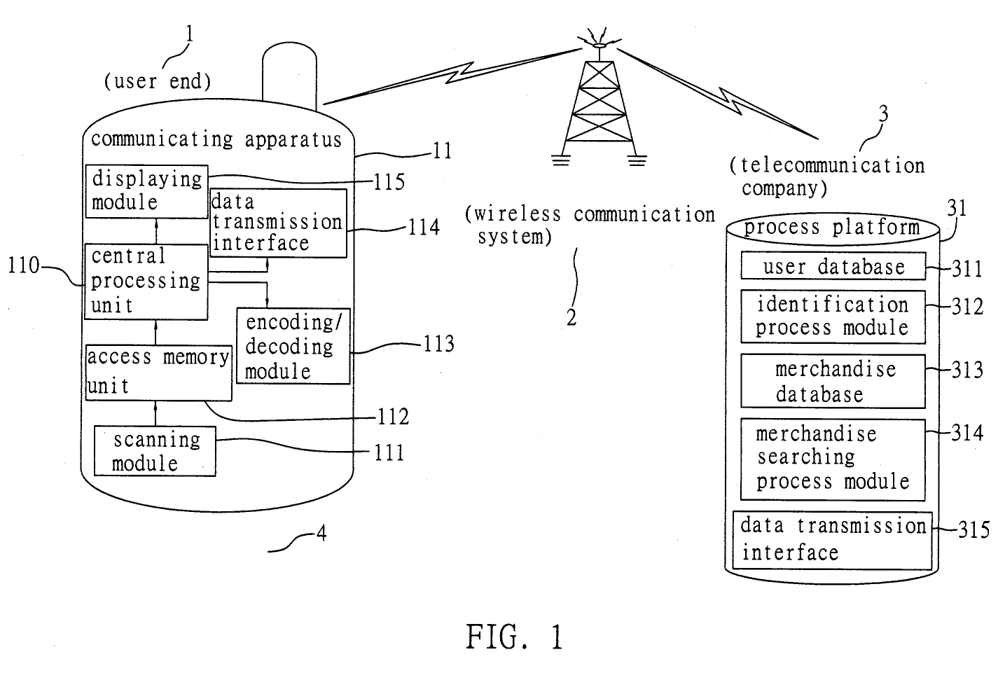

FIG. 1 is a block diagram illustrating the system for shopping by a communicating apparatus with a scanning function according to the present invention. The system comprises: a communicating apparatus 11 with a scanning function for an end user 1 and a process platform 31 for a telecommunication dealer 3, both are lined to each other by a wireless communication system 2. It should be noted that the process platform 31 described in this embodiment is not limited to be possessed by the telecommunication dealer 3 only, other communication dealers and electronic data providers may also set up the process platform 31.

The wireless communication system 2 is constructed with may cells, wherein each cell is selected from a group consisting of a macrocell and a microcell. Thus, the communicating apparatus 11 for the end user 1 and the process platform 31 for the telecommunication dealer 3 may transmit an analog signal through radio waves without being limited to factors, such as time and location. Since the radio wave communication system is well known to one skilled in the telecommunication network technology, a detailed description of its internal construction will be omitted herein.

The communicating apparatus 11 with a scanning function provides the end user 1 with a bar code 4 for the merchandise being scanned, and transmits the bar code of the merchandise so that the end user 1 can search or purchase the desired merchandise. The process platform 31 searches according to the message transmitted by the end user 1 for the bar code 4 of the merchandise. Therefore, the process platform 31 serves as a medium for end user 1 to purchase the merchandise.

The communicating apparatus 11 with the scanning function comprises at least a scanning module 111, an access memory unit 112, an encoding/decoding module 113, a data transmission interface 114, a displaying module 115, and a central processing unit 110 (CPU). The scanning module 111 allows the end user to scan the bar code of the merchandise to be purchased, whereas the access memory unit 112 saves the bar code scanned by the scanning module temporarily. The encoding/decoding module 113 then transforms the bar code 4 into a digital signal that can be read by the computer. And through the cells set up at different locations, the data transmission interface 114 transmits the bar code 4 and its related message using the radio saves to the process platform 31 for the telecommunication dealer 3 at the distant end. The displaying module 115 displays the bar code 4 of the merchandise and the message transmitted by the process platform 31. The CPU 110 serves to drive and process the memory, encoding/decoding, transmission, and displaying functions related to the bar code 4 in the communicating apparatus.

The process platform 31 comprises at least a user database 311, an identification process module 312, a merchandise database 313, a merchandise searching process module 314, and a data transmission interface 315. The user database 311 saves the information of the registered member in this shooing system, wherein each member information has a corresponding communication identity code, such as a personal identity number (PIN) assigned to the subscriber identity module (SIM) card of the mobile phone, so that the process platform 31 can determine if the communicating apparatus 11 for the end user 1 can use the shopping service in this system. After the process platform 31 receives the communication identity code for the communicating apparatus 11 that sends the purchasing request, the identification process module 312 determines according to the communication identity code in the user database 311 if the communicating apparatus has authority to use the shopping service. The merchandise database 313 saves a plurality of merchandise information provided by stores that have a cooperation with the telecommunication dealers 3, the merchandise information includes an identification bar code of the merchandise as well as function, specs, and cost of the merchandise. After the process platform receives the message related to the bar code 4 from the end user 1, the message is matched with the bar code content established in the merchandise database 313 by the merchandise searching process module 314. As a result, the information for the merchandise to be searched or purchased by the end user 1 is obtained. The data transmission interface 315 transmits the information related to the merchandise to the end user 1 and the stores. Therefore, the data transmission interface serves 315 as a medium to provide service related to purchasing or searching the merchandise.

The end user 1 can make selection or search according to the merchandise catalog regularly or casually provided by the stores. When the end user 1 decides on a merchandise to be purchased or searched, the scanning module 111 in the communicating apparatus 11 is adopted to scan the bar code 4 provided for the merchandise to be purchased or searched, before saving the bar code 4 in the access memory unit 112. The message for the bar code 4 that is temporarily saved in the access memory unit 112 is transmitted through the central processing unit (CPU) 110 to the displaying module 115, where the end user 1 confirms whether to continue the purchasing action. After the end user 1 has confirmed to continue the purchasing action, the message for the bar code 4 is transmitted to the encoding/decoding module 113, where the message is transformed into a digital signal that can be read by the computer. Next, the CPU 110 sends the digital signal to the data transmission interface 114, where the digital signal is transmitted as radio saves to the process platform 31 at the distant end.

Usually before the telecommunication dealer 3 permits the end user 1 to purchasing the merchandise using the communicating apparatus 11 with the scanning function through the radio waves a member identification is required. In other word, the member is determined based on the personal identity number (PIN) assigned to the subscriber identity module (SIM) card of the communicating apparatus 11. If the end user 1 logs in for the first time, the process platform would invite the end user 1 to register as a member and saves the member-only information in the user database 311 after the end user 1 completes the member registration. After the identity of the end user 1 is verified by the identification process module 312 of the process platform 31, the process platform 31 beings searching the merchandise to be purchased by the end user 1 according to the bar code message 4 of the merchandise received from the end user 1, such that the, merchandise searching process module 314 matches the bar code message 4 with the merchandise information established in the merchandise database 313. And with the data transmission interface 315 in the process platform 31, this trade content is transmitted to both the end user 1 who place order for the merchandise and to the store (not shown) that provides the merchandise, so as to complete the order for the merchandise desired by the end user 1. Finally, the store can negotiate with the end user 1 for methods of payment and delivery. For example, the good can be delivered by a home delivery service or the end user 1 may be informed of the pick-up location. In addition, regardless if the end user 1 is a member or not, the merchandise information can be searched by the communicating apparatus with the scanning function.

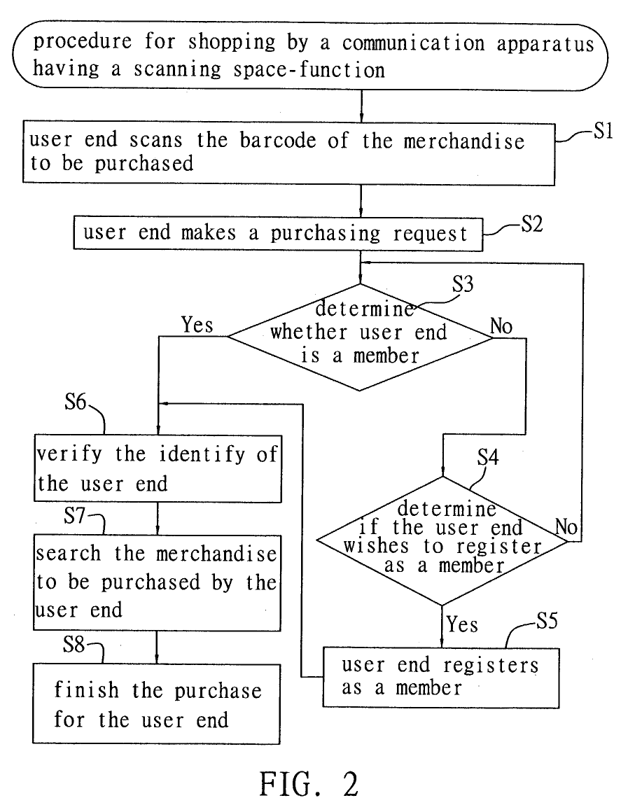

FIG. 2 is a flow chart illustrating the system for shopping by the communicating apparatus with scanning function according to the present invention. However, the description below is made with reference to both FIGS. 1 and 2.

First of all step S1 is executed where the end user 1 scans the bar code 4 of the merchandise to be purchased by the scanning module 111 in the communicating apparatus 11 before saving the bar code 4 in the access memory unit 112. Next, step S2 is executed.

In step S2, the end user 1 pushes the purchasing key (not shown) on the communicating apparatus 11, confirming the type of the merchandise to be purchased. And with the encoding/decoding module 113, the bar code is transformed to a different format, so that the purchasing information including the bar code message 4 is transmitted through the data transmission interface 114 as radio waves to the process platform 31 for the telecommunication dealer 3. Then, step S3 is executed.

In step S3, according to the personal identity number (PIN) included in the purchasing information, the process platform searches from the user database 311 for any matching identity number to determine if the end user 1 is a registered member for using this shopping service. If the end user 1 is a registered member, step S6 is executed. Otherwise, step S4 is executed instead.

In step S4, the process platform 31 sends a message informing the shopping service can not be used, followed by transmitting a message inviting the end user 1 to register as a member for using the shopping service. Then, a determination is made for whether the end user 1 wishes to register as a member. If the end user 1 wishes to register as a member, step S5 is executed. Otherwise, the procedure returns to step S3.

In step S5, the end user 1 registers as a member, wherein the end user 1 inputs his/her identity card number, user's password, and so on. And while the end user 1 operates the communicating apparatus to transmit the identity card number and the user's password, the PIN assigned to the SIM card of the communicating apparatus is also transmitted to the process platform 31, so that the information for the member registration is saved in the user database 313. Next, step S6 is executed.

In step S6, after the identification process module 312 in the process platform 31 has completed verifying the identity and password for the end user 1, the end user 1 is permitted to enter the shopping system. Then, step S7 is executed.

In step S7, according to the bar code message 4 transmitted by the end user 1 for the merchandise to be purchased, the merchandise searching process module 314 in the process platform 31 searches the merchandise detail established in the merchandise database 313 to locate the merchandise to be purchased by the end user 1. After that, step S8 is executed.

In step S8, the trade content is transmitted by the data transmission interface 315 in the process platform 31 to the end user 1 who places order for the merchandise and to the store that provides the merchandise, so as to complete the order for the merchandise desired by the end user 1. Moreover, the information related to the new product that the updated in the merchandise database by the store can be transmitted to the registered member, so as provide instant shopping service for new merchandise.

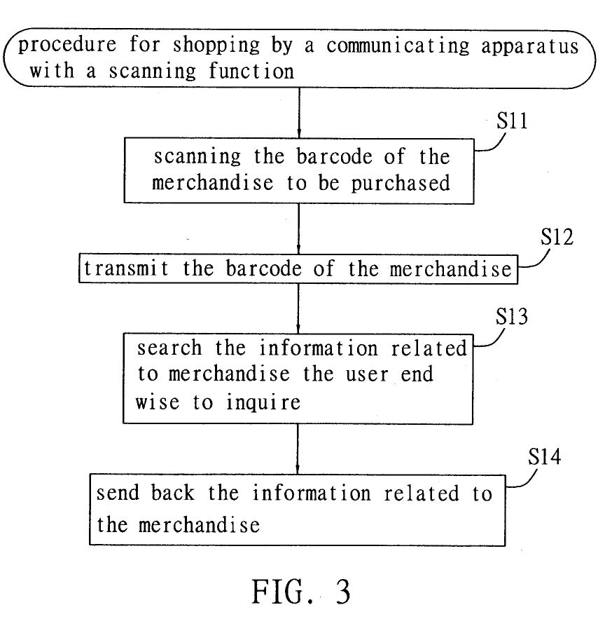

FIG. 3 is a flow chart illustrating the method of searching information related to the merchandise by the communicating apparatus with a scanning function according to the present invention. However, the description below is made with reference to both FIGS. 1 and 3.

First of all, step S11 is executed where the end user 1 scans the bar code 4 of the merchandise to be purchased by the scanning module 111 in the communicating apparatus 11 before saving the bar code 4 in the access memory unit 112. Next, step S12 is executed.

In step S12, the end user 1 pushes the searching key (not shown) on the communicating apparatus 11, confirming the type of the merchandise to be searched. And with the encoding/decoding module 113, the bar code 4 is transformed to a different format, so that the searching information including the bar code message 4 is transmitted through the data transmission interface 114 as a radio wave to the process platform 31 for the telecommunication dealer 3. Then, step S13 is executed.

In step S13, according to the bar code message 4 transmitted by the end user 1 for the merchandise to be searched, the merchandise searching process module 314 searches the merchandise detail established in the merchandise database 313 to locate the merchandise to be searched by the end user 1. After that, step S14 is executed.

In step S14, the information related to the merchandise is transmitted by the data transmission interface 315 in the process platform 31 to the communicating apparatus 11 with the scanning function, so that the end user 1 can browse the merchandise information from the displaying module 115 of the communicating apparatus 11.

According to the description above, the end user 1 can scan the bar code 4 corresponding to the desired merchandise anytime and anywhere by the communicating apparatus 11 with the scanning function. With the cells 2 set up at different locations, the bar code message 4 is transmitted as radio waves to the process platform 31 for the telecommunication dealer 3. By matching the bar code message 4 with the merchandise information established previously in the process platform 31, the end user 1 is provided with the information related to the merchandise, while informing the store the type of the merchandise purchased by the end user 1. As a result, this provides a more convenient and diverse shopping service between the shopper and the store.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A communicating apparatus with scanning function, applicable to an online shopping system such that a user scans a bar code of a merchandise to be purchased using the communicating apparatus and transmits data associated with the bar code through a communication system to process platform, provided the process platform is in-built with a database for all kinds of merchandises, whereby the user can search through the database to accomplish a purchase and an inquiry of the merchandise from an end user, the communicating apparatus comprising:
a scanning module, for scanning a bar code of the merchandise to be purchased or inquired;
a memory unit, for saving the bar code scanned by the scanning module;
an encoding/decoding module, for processing the bar code saved in the memory unit so as to form a digital signal readable by a computer;
a data transferring interface, for transmitting the bar code and its associated data to a process platform;
a displaying module, for displaying the merchandise data associated to the bar code transmitted from the process platform; and
a central processing unit, for driving and integrating the scanning module, the memory unit, the encoding/decoding module, the data transferring interface and the displaying module.

2. The communicating apparatus according to claim 1, wherein the process platform is set up by one selected from a group consisting of telecommunication traffickers, telecommunication providers, and electronic data providers.

3. The communicating apparatus according to claim 1, wherein the process platform comprising at least:
a user data base stored with at least a communication identity code of the communication apparatus with scanning function at the user end, for determining if the end user can be provided with shopping service;
an identifying module, for
a merchandise data base;
a searching module; and
a data transfer interface.

4. The communicating apparatus according to claim 3, wherein the communication identity code is a personal identification number (PIN) saved in a subscriber identify module (SIM) of the communication apparatus.

5. The communicating apparatus according to claim 1, wherein the communication system includes a cell selected from a group consisting of a macrocell and microcell for transmitting an analog signal using radio waves.
